(19) United States
(12) Patent Application Publication
(10) Pub. No.: US 2017/0369825 A1
(43) Pub. Date: Dec. 28, 2017

(54) CONTAINER ASSEMBLY WITH A BREATHABLE MEMBRANE OXYGENATOR

(71) Applicant: Jonathan William Roleder, San Diego, CA (US)

(72) Inventor: Jonathan William Roleder, San Diego, CA (US)

(21) Appl. No.: 15/537,826

(22) PCT Filed: Dec. 23, 2015
(86) PCT No.: PCT/US15/00169

§ 371 Date: Jun. 19, 2017

Related U.S. Application Data
(60) Provisional application No. 62/095,555, filed on Dec. 22, 2014.

(51) Int. Cl. C12H 1/14; C12H 1/22

(52) U.S. Cl. CPC C12H 1/14; C12H 1/22

(57) ABSTRACT

A container assembly (10) for aging a liquid (14) includes: a container (12) that retains the liquid (14) being aged, the container (12) including a container aperture (24); and an oxygenator (16) that is positioned adjacent to the container aperture (24), the oxygenator (16) including a porous oxygenator membrane (38B) that allows for the flow of air into the container (12) through the oxygenator membrane (38B) and the container aperture (24).

### RELATED INVENTIONS

This application claims priority on U.S. Provisional Application No. 62/095,555 filed on Dec. 22, 2014 and entitled “OXYGENATOR ASSEMBLY CONTAINING A BREATHABLE MEMBRANE SYSTEM”. As far as permitted, the contents of U.S. Provisional Application No. 62/095,555 are incorporated herein by reference.

As far as permitted, the contents of PCT application Ser. No. PCT/US10/52721 entitled “CONTAINER ASSEMBLY FOR AGING A LIQUID”, filed on Oct. 14, 2010, is incorporated herein by reference. As far as permitted, the contents of PCT application Ser. No. PCT/US12/51012 entitled “CONTAINER ASSEMBLY WITH IMPROVED RETAINER ASSEMBLY AND FLAVOR INSERTS FOR AGING A LIQUID”, filed on Aug. 15, 2012, is incorporate herein by reference.

### BACKGROUND

There is a continual effort to improve the performance and ease of use of containers used to age liquids. A popular container for aging a liquid is a 55 gallon wooden barrel. Wood is a porous material that allows oxygen from the outside to pass into the liquid being aged through the pores in the wood.

### SUMMARY

The present invention is directed to a container assembly for aging a liquid, the container assembly comprising: a container that retains the liquid being aged, the container including a container aperture; and an oxygenator that is positioned adjacent to the container aperture, the oxygenator including a porous oxygenator membrane that allows for the flow of air into the container through the oxygenator membrane and the container aperture.

In one embodiment, the container is made of a material that prevents the flow of oxygen through the container. For example, the container can be made of stainless steel.

In alternative non-exclusive examples, the oxygenator membrane can have a porosity of approximately five percent, approximately six percent, or approximately ten percent.

Further, in alternative, non-exclusive examples, the oxygenator membrane can have a porosity that allows for the oxygen transfer of (i) at least 0.5 milliliters of oxygen per liter of liquid, per month through the oxygenator membrane; (ii) at least 0.8 milliliters of oxygen per liter of liquid, per month through the oxygenator membrane; or (iii) at least 1 milliliter of oxygen per liter of liquid, per month through the oxygenator membrane. Stated in another fashion, in alternative, non-exclusive examples, the breathable membrane can be designed to allow an oxygen transfer rate of between approximately (i) 0.5 to 1.5 milliliters of oxygen per liter of liquid, per month therethrough; (ii) 0.6 to 1.4 milliliters of oxygen per liter of liquid, per month therethrough; (iii) 0.7 to 1.3 milliliters of oxygen per liter of liquid per month therethrough; (iv) 0.8 to 1.2 milliliters of oxygen per liter of liquid, per month threrethrough; or (v) 0.9 to 1.1 milliliters of oxygen per liter of liquid, per month threrthrough.

Moreover, in alternative, non-exclusive examples, the oxygenator membrane can have a porosity that allows for the air transfer of (i) at least 0.5 milliliters of air per liter of liquid, per month through the oxygenator membrane; (ii) at least 0.8 milliliters of air per liter of liquid, per month through the oxygenator membrane; or (iii) at least 1 milliliter of air per liter of liquid, per month through the oxygenator membrane. Stated in yet another fashion, in alternative, non-exclusive examples, the breathable membrane can be designed to allow an air transfer rate of between approximately (i) 0.5 to 1.5 milliliters of air per liter of liquid, per month therethrough; (ii) 0.6 to 1.4 milliliters of air per liter of liquid, per month therethrough; (iii) 0.7 to 1.3 milliliters of air per liter of liquid per month therethrough; (iv) 0.8 to 1.2 milliliters of air per liter of liquid, per month threrethrough; or (v) 0.9 to 1.1 milliliters of air per liter of liquid, per month threrthrough.

In one embodiment, the container includes a container top, a container bottom, and a container side wall that extends between the container top and the container bottom. For example, the container aperture can extends through the container side wall.

Additionally, the oxygenator can include a flow control device for controlling the flow of oxygen through the oxygenator membrane. For example, the flow control device can include a cap that covers the oxygenator membrane.

In certain embodiments, the container is positioned so that the oxygenator membrane remains dry during the aging process.

Further, the oxygenator membrane can be interchangeable to adjust the air flow rate into the container through the oxygenator membrane and the container aperture.

The present invention is also directed to a method for aging a liquid that includes (i) putting the liquid in a container that retains the liquid being aged, the container including a container aperture; and (ii) positioning an oxygenator adjacent to the container aperture, the oxygenator including a porous oxygenator membrane that allows for the flow of air into the container through the oxygenator membrane and the container aperture.

In another embodiment, the present invention is directed to an oxygenator assembly including a breathable membrane system. The oxygenator assembly is adjustable to allow the optimal amount of oxygen to pass from the outside air into a liquid being aged. In one embodiment, the breathable membrane system includes a breathable material that allows oxygen to pass into a liquid being aged but does not allow the liquid being aged to pass through the breathable membrane. In certain embodiments, the oxygenator assembly is designed to be attached to a container in which a liquid is being aged. The oxygenator assembly is designed to be easily adjustable so that for a liquid being aged, it is easy to adjust the oxygen transfer rate to the optimal oxygen transfer rate.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective, partly exploded view of a container assembly that includes an oxygenator;

FIG. 2 is a cutaway view of the container assembly of FIG. 1;

FIG. 3 is an enlarged view taken from FIG. 2;

FIG. 4 is a perspective view of an assembly including a couple of container assemblies;

FIG. 5 is a top view of a plurality of alternative membranes;

FIG. 6 is an exploded perspective view of a portion of another embodiment of a container assembly; and

FIG. 7 is an exploded perspective view of the oxygenator of FIG. 6.

### DESCRIPTION

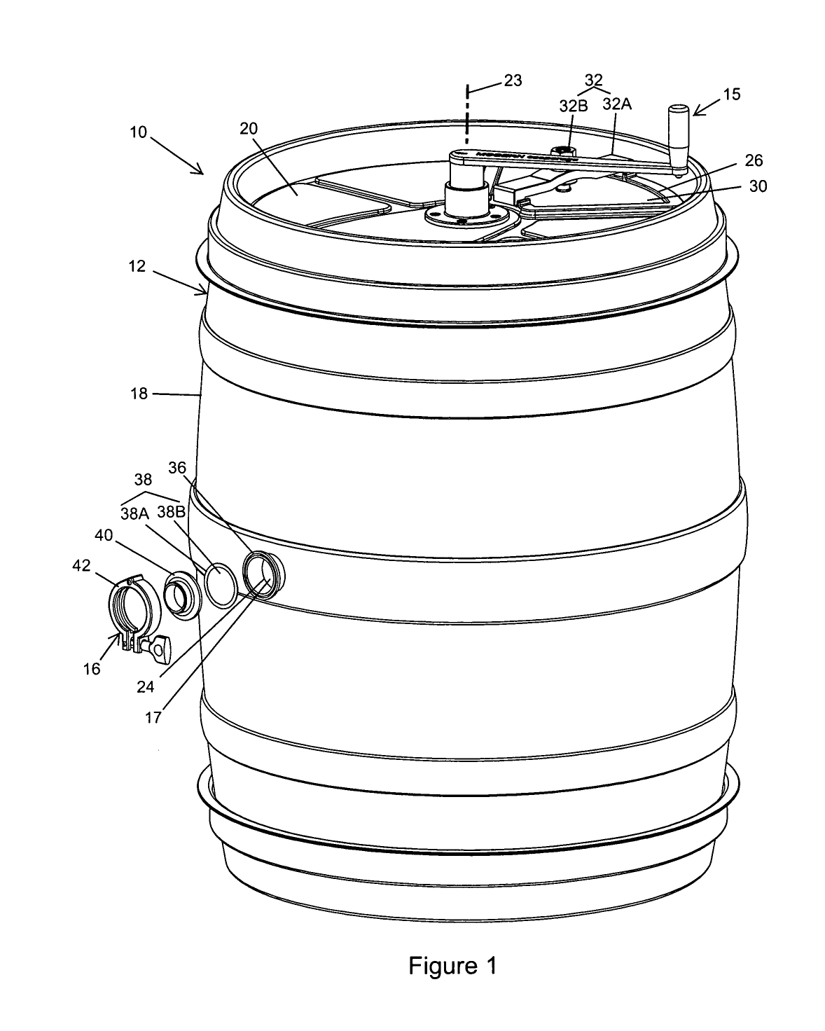

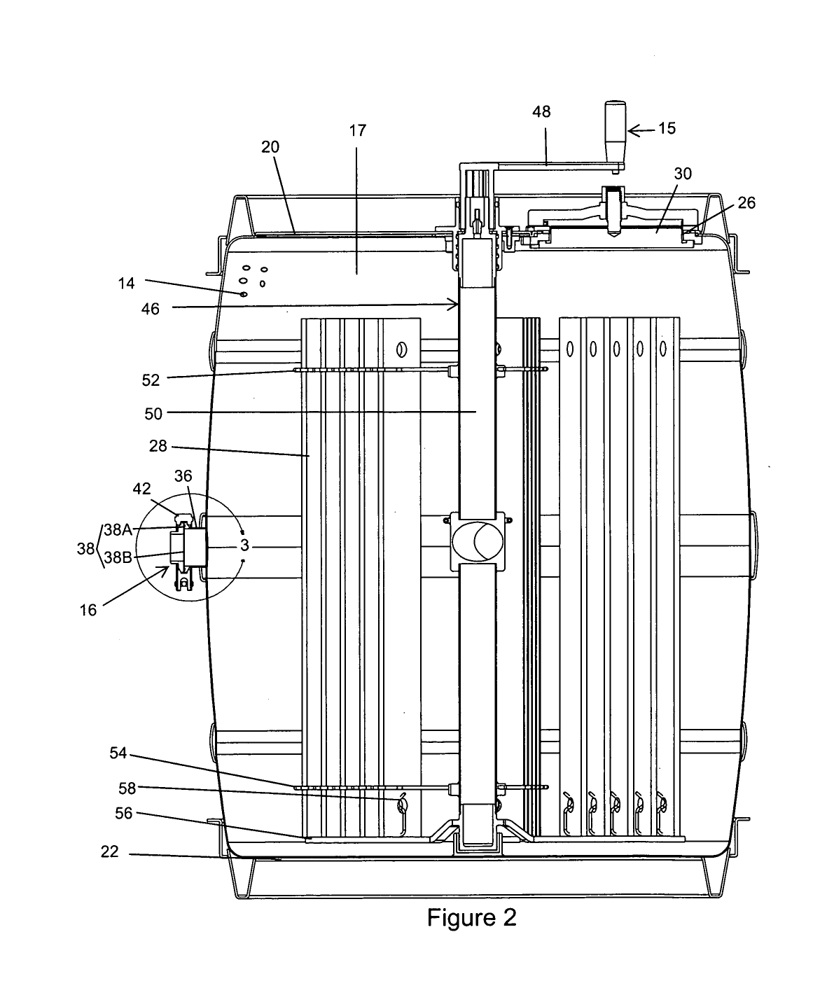

FIG. 1 is a partly exploded perspective view of a non-exclusive embodiment of a container assembly 10. In this embodiment, the container assembly 10 includes a container 12 that retains a liquid 14 (illustrated with a few small circles in FIG. 2) during the aging process, an insert assembly 15 (only a portion is illustrated in FIG. 1) that imparts a flavor on the liquid 14, and one or more oxygenators 16 (also referred to as “breathing device”). The container 12 is non-porous and can be made of stainless steel or other suitable material. Further, the oxygenator 16 is uniquely designed to allow for the gradual aeration of the liquid 14 over a prolonged period. With this design, a container 12 made of stainless steel can be used during aging of the liquid 14 while still exhibiting the natural properties of a wood barrel.

Stated in another fashion, the container assembly 10 is uniquely designed to mimic the same effect that a traditional wood barrel (not shown) has when aging of the liquid 14. One inherent quality of a wooden barrel is the material it is manufactured from, typically oak wood, which is porous. Wood has a specific porosity, which allows air or oxygen to pass through it. When wood is used to construct the barrel, there is a measurable amount of oxygen that passes through the wood from the outside of the barrel to the liquid on the inside of the barrel. While the wood barrel has an inherent quality of allowing a desirable amount of oxygen to affect the aging liquid inside, it also has many undesirable qualities and limitations. The present oxygenator 16 provides the ability to control the amount of oxygen transfer either by allowing more oxygen transfer into the liquid 14, by allowing less oxygen transfer into the liquid 14, or by completely preventing oxygen transfer into the liquid 14 into the container 12.

As a result thereof, the container assembly 10 allows for the total control of the aging of the liquid 14, including optimum processing and aging opportunities for the liquid 14. Stated another way, the container assembly 10 can be used to precisely create the perfect environment for aging the liquid 14 so that the highest quality beverage can be achieved. Further, the container assembly 10 can be easily adjusted to be used for different types of liquids 14, and the container assembly 10 can be adjusted during the aging process, if necessary, to alter the aging process.

The container 12 forms a chamber 17 that retains the liquid 14 during the aging process. The design, size and shape of the container 12 can be varied. In FIG. 1, the container 12 is shaped somewhat similar to a traditional, cylindrical shaped wine barrel that is sized to retain 55 gallons of liquid 14. Alternatively, the container 12 can have a different shape or size. As alternative, non-exclusive examples, the container 12 is sized and shaped to retain approximately 5, 10, 25, 55, 100, 500, 1000, 2500 or 5000 gallons of liquid 14. However, the container 12 can be larger or smaller.

In one, non-exclusive embodiment, the container 12 is made from materials that impart substantially no flavor on the liquid 14 and that are substantially liquid impervious and do not absorb any liquid 14. In certain embodiments, the container 12 is non-porous, air tight at atmospheric pressure (and up to ten PSI above atmospheric pressure). As provided above, the container 12 can be made of stainless steel, aluminum or another suitable, food grade material.

In certain embodiments, the container 12 is non-porous to the liquid 14 and the oxygen. With this design, the chamber 17 is fully sealed except of the air that passes through the oxygenator 16. Stated in another fashion, air or oxygen can only enter the chamber 17 via the oxygenator 16.

In FIGS. 1 and 2, the container 12 includes a tubular shaped container side wall 18, a disk shaped container top 20, and a disk shaped container bottom 22 (illustrated in FIG. 2). For example, in one embodiment, the side wall 18, the bottom 22 and the top 24 can be made of stainless steel or aluminum. Moreover, the container 12 can include a container longitudinal axis 23.

Additionally, in this embodiment, the container 12 includes a container aperture 24 for the oxygenator 16. In this embodiment, the container aperture 24 is an opening that extends through the side wall 18 transverse (and radial) to the container longitudinal axis 23. In this embodiment, container aperture 24 is positioned similar to a traditional bunghole of a wine barrel that extends through the side wall 18. With this design, when the container 12 can be positioned on its side, the oxygenator 16 can be removed, and the liquid 14 can be added to or removed from the container 12 via the container aperture 24. Subsequently, the oxygenator 16 can be attached to the container 12 so that the container assembly 10 is ready for aging the liquid 14.

Alternatively, the container aperture 24 can be positioned in another location, e.g. extend through the container top 20.

In one embodiment, the container aperture 24 is a circular shaped opening having a diameter of approximately 2 inches. As alternative, non-exclusive examples, the container aperture 24 can have a diameter of approximately 1, 1.5, 2, 2.5, 3, 3.5, 4, 4.5, of 5 inches, and/or the container aperture 24 can have a different shape. The container aperture 24 is designed to be small enough to not significantly influence the structural integrity (significantly reduce the strength) of the container side wall 18, while large enough to allow for aeration, filling and/or emptying the container 12.

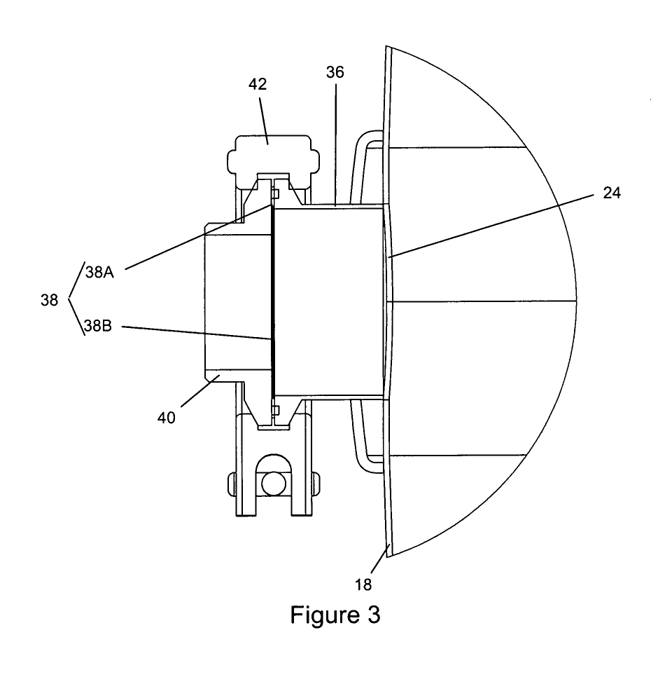

Additionally, in certain embodiments, the container top 20 can include a top aperture 26 for easily adding or removing one or more flavor inserts 28 (illustrated in FIG. 3) into the container 12, and a container door 30 that is used to selectively open the top aperture 26 to allow for access to the flavor inserts 28, and is closed to seal the chamber 17. In one non-exclusive embodiment, the top aperture 26 has a truncated pie shape, and the container door 30 has a truncated pie shape. Further, in this embodiment, container assembly 10 includes a door latch 32 that selectively secures the container door 30 to the container top 20. In one embodiment, the door latch 32 includes a latch beam 32A and a latch fastener 32B that are selective controlled to lock and unlock the container door 30.

With the present design, the container 12 can be easily cleaned and reused with many different liquids 14. Moreover, having the ability to quickly and easily change the flavor inserts 28 through the top aperture 26 allows the user to easily convert this container 12 from one type of wood flavoring component to another, without having to purchase entirely new containers. Thus, the present invention provides many economic, environmental and manufacturing advantages over the older more traditional aging equipment. For example, once the initial investment in the container 12 is made, the cost to achieve the highest barrel quality is only a function of the cost of the flavor inserts 28.

The type of liquid 14 aged in the container assembly 10 can vary. For example, the liquid 14 can be a red wine, white wine, port, whiskey, brandy, or other beverages.

The insert assembly 15 can be used to impart a flavor on the liquid 14 during an aging process. The insert assembly 15 is discussed in more detail below in the discussion of FIG. 2.

The oxygenator 16 allow for the gradual aeration of the liquid 14 over a prolonged period through the container aperture 24. FIG. 1 illustrates the oxygenator 16 in the exploded position and FIG. 2 illustrates the oxygenator 16 in the assembled position. Exposure to oxygen during the aging process can improve the liquid 14. Too much oxygen can lead to oxidation, while too little oxygen can inhibit the aging process. The present invention provides a unique way to precisely control the flow rate of the oxygen to the liquid 14 during the aging process.

The present oxygenator 16 provides the ability to precisely control the amount of oxygen transfer either by allowing more oxygen transfer into the liquid 14, by allowing less oxygen transfer into the liquid 14, or by completely preventing oxygen transfer into the liquid 14. Further, in certain embodiments, the oxygenator 16 is passive.

As provided herein, the size, shape, and oxygen flow characteristics of the oxygenator 16 can be varied to suit the size of the container 12, the type of liquid 14 being aged, and the desired rate of oxygen transfer to the liquid 14. For example, the oxygenator 16 for a 55 gallon container 12 can be designed to simulate and approximate the flow rate of oxygen through a typical 55-gallon wood barrel. In one non-exclusive example, a typical 55-gallon wood barrel allows approximately one (1) milliliter per liter per month of oxygen transfer. This breathable characteristic of traditional wood barrel containers has long been a desirable feature in the wine, spirits, beer and food industries.

In one non-exclusive embodiment, the oxygenator 16 is designed to allow approximately one (1) milliliter per liter per month of oxygen transfer from outside the container 12 to inside the container 12. Alternatively, the oxygenator 16 can be designed to allow an oxygen transfer of approximately 0.5, 1, 1.5, 2, 3, 4, or 5 milliliters of oxygen per liter of liquid, per month from outside the container 12 to inside the container 12. However, other rates can be achieved by changing the design of the oxygenator 16.

FIGS. 1 and 2 illustrate the components of one, non-exclusive example, of the oxygenator 16. In this non-exclusive embodiment, the oxygenator 16 includes an oxygenator base 36 that is fixedly attached to the container 12 (e.g. by welding) around the container aperture 24 and sealed to the container 12. In the non-exclusive embodiment illustrated, oxygenator base 36 can be made of stainless steel, the diameter of the oxygenator base 36 can be approximately two inches and the shape of the oxygenator base 36 can be substantially cylindrical shaped. Alternatively, the diameter of the oxygenator base 36 could be more than two inches or less than two inches and the shape of the oxygenator base 36 could be another shape.

Sitting on top of the oxygenator base 36 and attached to the oxygenator base 36 is an oxygenator filter 38 (also referred to as “membrane” or “membrane material”) 56. In this embodiment, the oxygenator filter 38 contains a support ring 38A and a breathable oxygenator membrane 38B. The breathable oxygenator membrane 38B allows oxygen from the outside air to pass through the container aperture 24 and into the liquid 14 being aged in the container 12. The breathable membrane 38B also inhibits the liquid 14 being aged in the container 12 from passing through the breathable membrane 38B. The oxygenator filter 38 containing the breathable membrane 38B is sized and shaped so that the oxygenator filter 38 snugly fits on top of the oxygenator base 36. In the non-exclusive embodiment illustrated in FIG. 2, the oxygenator filter 38 is disk shaped, the support ring 38A is flat ring shaped, and the breathable membrane 38B is disk shaped. Alternatively, the shapes of the oxygenator filter 38, the support ring 38A, and the breathable membrane 38B could be another shape. Further, in this embodiment, the oxygenator filter 38 is not inside the chamber 17, but cooperates with the container 12 to form the chamber 17.

The breathable membrane 38B can be manufactured from a material of known porosity in a desired size, shape, and thickness to give the breathable membrane 38B the desired amount of breathability thus allowing the desired amount of oxygen transfer into the liquid being aged. The breathable membrane 38B can be fabricated in different ways. In one non-exclusive embodiment, the material of the breathable membrane 38B can be fabricated by molding. An advantage of molding is that a reinforcing material such as stainless steel wire mesh screen can be incorporated into the breathable membrane 38B. The stainless steel wire mesh screen adds strength to the breathable membrane 38B. A strong breathable membrane 38B is desirable if the container 12 is stored in a location where it could be contacted by an object that could damage the oxygenator 16 by puncturing or tearing the breathable membrane 38B. In alternative, non-exclusive examples, the breathable membrane 38B has a diameter of approximately 1, 1.5, 2, 2.5, 3, 3.5, or 4 inches. Stated in another fashion, in alternative, non-exclusive examples, the breathable membrane 38B has an area of approximately 0.78, 1.77, 3.14, 4.9, 7.1, 9.6, or 12.57 inches squared.

The porosity of the breathable membrane 38B can be varied to achieve the desired oxygen transfer rate. As alternative, non-exclusive examples, the breathable membrane 38B can have a porosity of approximately 0.01%, 5%, 6%, 10%, 35%, 50%, 99% or 100%. Further, the breathable membrane 38B can have a porosity that is at least 99% greater than the porosity of the container 12.

Stated in another fashion, in alternative, non-exclusive examples, the breathable membrane 38B can allow oxygen transfer of approximately 0.5, 0.6, 0.7, 0.8, 0.9, 1, 1.1, 1.2, 1.3, 1.4, 1.5, or 2 milliliters of oxygen per liter of liquid per month therethrough. However, other rates are possible. In certain embodiments, approximately shall mean within plus or minus 0.2 milliliters of oxygen per liter of liquid per month. Thus, the design of the breathable membrane 38B will depend on the size of the container 12 (or the amount of liquid 14 to be aged). Thus, the container 12 can be designed to retain a predetermined amount of liquid 14 during the aging process and the breathable membrane 38B can be designed based on that predetermined amount. As a non-exclusive example, if the container 12 is a fifty-five gallon (208.2 liter) container, and it is desired by the winemaker to have an oxygen transfer rate of 1 milliliter of oxygen per liter of liquid, per month, then the breathable membrane 38B is designed to allow an oxygen transfer of 208.2 milliliters of oxygen per month to the chamber 17. As an alternative example, if the container 12 is a one thousand liter container, and it is desired by the winemaker to have an oxygen transfer rate of 1 milliliter of oxygen per liter of liquid per month, then the breathable membrane 38B is designed to allow 1000 milliliters of oxygen per month to the chamber 17.

In another embodiment, in alternative, non-exclusive examples, the breathable membrane 38B can allow air transfer of approximately 0.5, 0.6, 0.7, 0.8, 0.9, 1, 1.1, 1.2, 1.3, 1.4, 1.5, or 2 milliliters of air per liter of liquid per month therethrough.

In still another embodiment, in alternative, non-exclusive examples, the breathable membrane 38B can be designed to allow an oxygen transfer rate of between approximately (i) 0.5 to 1.5 milliliters of oxygen per liter of liquid, per month therethrough; (ii) 0.6 to 1.4 milliliters of oxygen per liter of liquid, per month therethrough; (iii) 0.7 to 1.3 milliliters of oxygen per liter of liquid per month therethrough; (iv) 0.8 to 1.2 milliliters of oxygen per liter of liquid, per month threrethrough; or (v) 0.9 to 1.1 milliliters of oxygen per liter of liquid, per month threrthrough.

In yet another embodiment, in alternative, non-exclusive examples, the breathable membrane 38B can be designed to allow an air transfer rate of between approximately (i) 0.5 to 1.5 milliliters of air per liter of liquid, per month therethrough; (ii) 0.6 to 1.4 milliliters of air per liter of liquid, per month therethrough; (iii) 0.7 to 1.3 milliliters of air per liter of liquid per month therethrough; (iv) 0.8 to 1.2 milliliters of air per liter of liquid, per month threrethrough; or (v) 0.9 to 1.1 milliliters of air per liter of liquid, per month threrthrough.

It should be noted that the porosity of the breathable membrane 38B can be (i) increased for smaller diameter membranes 38B and/or larger containers 12, and (ii) decreased for larger diameter membranes 38B and/or small containers 12.

As provided above, the container 12 is air tight and all of the oxygen that flows into the chamber 17 must pass through the oxygenator 16. In this embodiment, the container 12 can allow approximately zero milliliters per liter per month of oxygen transfer therethrough. This allows for the ability to precisely engineer and control the amount of oxygen transfer into the liquid 14 through the design of the oxygenator 16. In one non-exclusive embodiment, after the container 12 is closed with the oxygenator 16 and during the aging process, at least 99 percent of the oxygen transferred into the chamber 17 occurs through oxygenator 16. Stated in another fashion, in one embodiment, after the container 12 is closed with the oxygenator 16 and during the aging process, approximately 100 percent of the oxygen transferred into the chamber 17 occurs through oxygenator 16.

It should be noted that typically, the container 12 is typically positioned at approximately atmospheric pressure during the aging process. However, the porosity of the oxygenator membrane 38B could be selected based on the approximate pressure of the air outside the container 12 during the aging process.

If the container 10 is stored on its side, the breathable membrane 38B can be changed during the aging process with the container 10 full of liquid 14, if desired, to adjust and fine tune the aging process of the liquid 14. Stated in another fashion, multiple breathable membranes 38B can be interchanged as necessary to achieve the desired oxygen transfer rate.

Additionally, in this example, if the container 10 is stored on its side, the liquid 14 is not in direct contact with the breathable membrane 38B during the aging process. Alternatively, the oxygenator 16 can be alternatively located to be in contact with the liquid 14 during the aging process.

It should be noted that in certain embodiments, the oxygenator 16 provided herein is a passive system that does not require the pumping and/or storage of oxygen during the oxygen transfer. This greatly simplifies the system design.

Positioned on top of the oxygenator filter 38 is an oxygenator receiver flange 40. The material from which the oxygenator receiving flange 40 is made is typically a material that is impermeable to air, such as stainless steel. Thus when the oxygenator receiver flange 40 of the oxygenator 16 is sealed, no air reaches the breathable membrane 38B. Conversely when the oxygenator receiver flange 40 of the oxygenator 16 is unsealed, air can reach the breathable membrane 38B. In the non-exclusive embodiment illustrated in the Figures, the diameter of the oxygenator receiver flange 40 is approximately two inches and the shape of the oxygenator receiver flange 40 is substantially round. Alternatively, the diameter of the oxygenator receiver flange 40 could be greater than two inches or less than two inches and the shape of the oxygenator receiver flange 40 could be another shape.

In FIGS. 1 and 2, an oxygenator clamp 42 securely holds the oxygenator receiver flange 40 on top of the oxygenator base 36 with the support ring 38A of the oxygenator filter 38 therebetween. With this design, the oxygenator clamp 42 can be locked to secure the oxygenator filter 38 to the oxygenator base 36 so that oxygen must flows through the oxygenator filter 38 to reach the chamber 17. Further, the oxygenator clamp 42 can be unlocked to remove and/or replace the oxygenator filter 38.

In the non-exclusive embodiment illustrated, the oxygenator clamp 42 is substantially round, tri clover clamp. Alternatively, the oxygenator clamp 42 could be another shape, or another type of clamp can be used.

Additionally, the oxygenator 16 includes an additional flow control device (not shown in FIG. 2) that controls the flow of the fluid through the breathable membrane 38B. For example, the flow control device can be a cap that snugly and selectively fits on the oxygenator receiver flange 40.

With this present design, the breathability characteristics are easily controlled by selectively changing the membrane 38B. The membrane 38B allows oxygen to travel through it in one direction and in the other direction it retains the liquid 14 in the container 12. When this membrane 38B is manufactured to certain specifications and attached to a container 12, it will allow a controlled amount of oxygen to pass into the liquid 14 inside the container 12 and have a positive outcome.

Further, a closure cap would basically be an “on/off switch” allowing the invention to be used when needed and shut off when not needed. The ability for a container 12 to retain a liquid and have a controlled breathing membrane 38B attached in a way that it can be used on demand and in the specific amount needed is new and novel.

It should be noted that a pressurized vessel (not shown, e.g. an oxygen bottle) containing oxygen or another gas (not shown) could be connected in fluid communication with the oxygenator receiver flange 40. In this embodiment, the porosity of the oxygenator membrane 38B could be selected (based on the pressure inside the pressurized vessel) to still achieve the desired transfer rate of gas to the liquid 14 during the aging process.

FIG. 2 is a cut-away view of the container assembly 10 of FIG. 1. FIG. 2 illustrates the liquid 14 in the chamber 17 and the insert assembly 15 positioned in the chamber 17 of the container 12. As provided above, the insert assembly 15 is used to impart a flavor on the liquid 14. In one non-exclusive embodiment, the insert assembly 15 includes a retainer rack 46, a plurality of flavor inserts 28 that are selectively retained by the retainer rack 46, and a rack rotator 48.

The design of the retainer rack 46 can be varied. In one embodiment, retainer rack 46 retains the flavor inserts 28 spaced apart from each other so that almost the entirety of each flavor insert 28 is exposed to the liquid 14 in the chamber 17. Further, in one embodiment, the retainer rack 46 retains the flavor inserts 28 in a fashion that allows the flavor inserts 28 to expand and contract. In one embodiment, the retainer rack 46 include (i) a central hub 50 that is pivotable connect (e.g. with bearings) to the container top 20 and the container bottom 22; (ii) a plurality of spaced apart, upper retainer arms 52 that extend radially from the central hub 50; (iii) a plurality of spaced apart, lower retainer arms 54 that extend radially from the central hub 50; (iv) a retainer base 56; and (v) a plurality of spaced apart retainer clips 58 that are secured to and extend away from the retainer base 56.

In this embodiment, each retainer arm 52, 54 includes a plurality of spaced apart apertures (e.g. five apertures) for receiving the flavor inserts 28. With this design, each flavor insert 28 extends through an aperture in one of the upper retainer arms 52 and a corresponding aperture in one of the lower retainer arms 54 and is retained by one of the retainer clips 58.

In one non-exclusive embodiment, the retainer rack 46 can retain up to thirty flavor inserts 28. In this embodiment, the retainer rack 46 includes six retainer arms 52, six lower retainer arms 54, and retains the flavor inserts 28 in six rows of five flavor inserts 28. Alternatively, the retainer rack 46 can be designed to retain more than or fewer than thirty flavor inserts 28.

With the present design, when the flavor inserts 28 are positioned within the retainer rack 46, the flavor inserts 28 are inhibited from moving (e.g., floating) upward relative to the container 12 along the container longitudinal axis. Moreover, this design enables the flavor inserts 28 to be maintained spaced apart from the top 20.

Further, with the present design, each individual flavor insert 28 can be added to or removed from the retainer rack 46 through the top aperture 26 when the door 30 is removed.

In one embodiment, the components of the retainer rack 46 can be made of stainless steel or another suitable material.

The flavor inserts 28 are used to impart a desired flavor on the liquid 14 during the aging process. The number of flavor inserts 28 utilized and the type of flavor inserts 28 utilized can be adjusted to precisely adjust the desired outcome of the liquid 14. With this design, the perfect material and the perfect amount of material for the liquid 14 for extracting flavor during the aging process can be utilized. With the ability to change the number and types of flavor inserts 28 utilized during the aging process, the present invention provides great flexibility in the timing and the flavor development of the liquid 14 during the aging process. As non-exclusive examples, one or more of the flavor inserts 28 can be made of different species of wood, such as white oak, red oak, redwood, douglas fir, maple, birch, hickory, and/or any combination thereof.

In one embodiment, each flavor insert 28 is generally thin beam shaped and has a generally rectangular shaped cross-section. Alternatively, for example, one or more of the flavor inserts 28 can have another cross-sectional shape, such as a circular, oval, triangle, or an octagon.

The rack rotator 48 can be used to selectively rotate the retainer rack 46 and the flavor inserts 28. In one embodiment, the rack rotator 48 is a handle attached to the retainer rack 46. Alternatively, for example, the rack rotator 48 can be a motor.

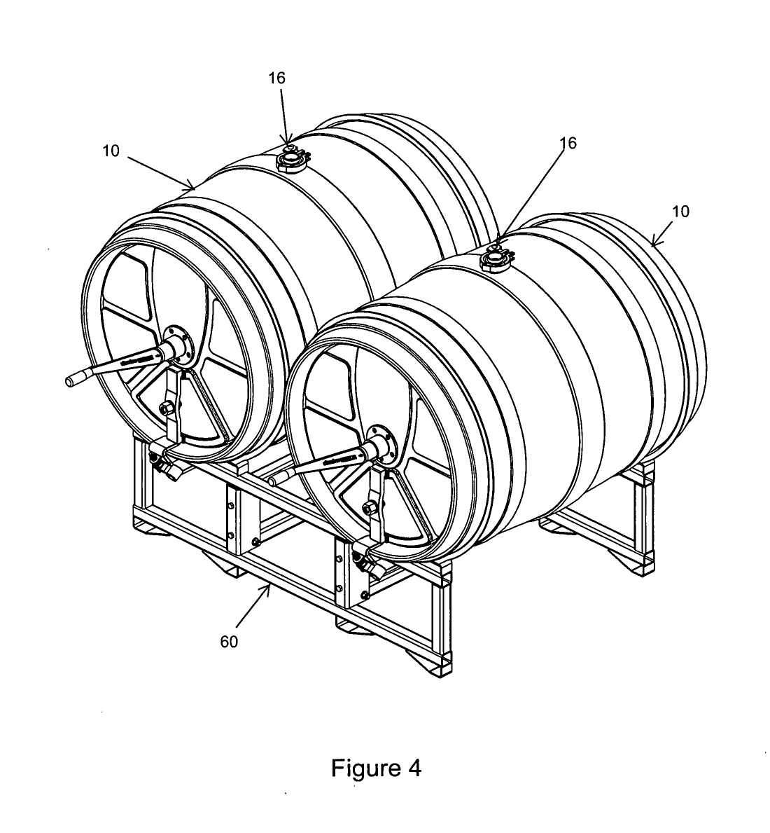

FIG. 3 is an enlarged cut-away view taken from FIG. 2. FIG. 3 illustrates the container aperture 24 that extends through the container side wall 18. Also, FIG. 4 illustrates the oxygenator base 36, the oxygenator filter 38, the oxygenator receiver flange 40, and the oxygenator clamp 42 in the assembled position.

FIG. 4 is a perspective view of two container assemblies 10 positioned on a storage rack 60 during the aging process. In this embodiment, the oxygenator 16 of each container assembly 10 is positioned the highest point. With this design, the liquid 14 (illustrated in FIG. 2) is not in contact with the membrane 38B (illustrated in FIG. 3) during aging and the membrane 38B can be selectively switched during the aging process.

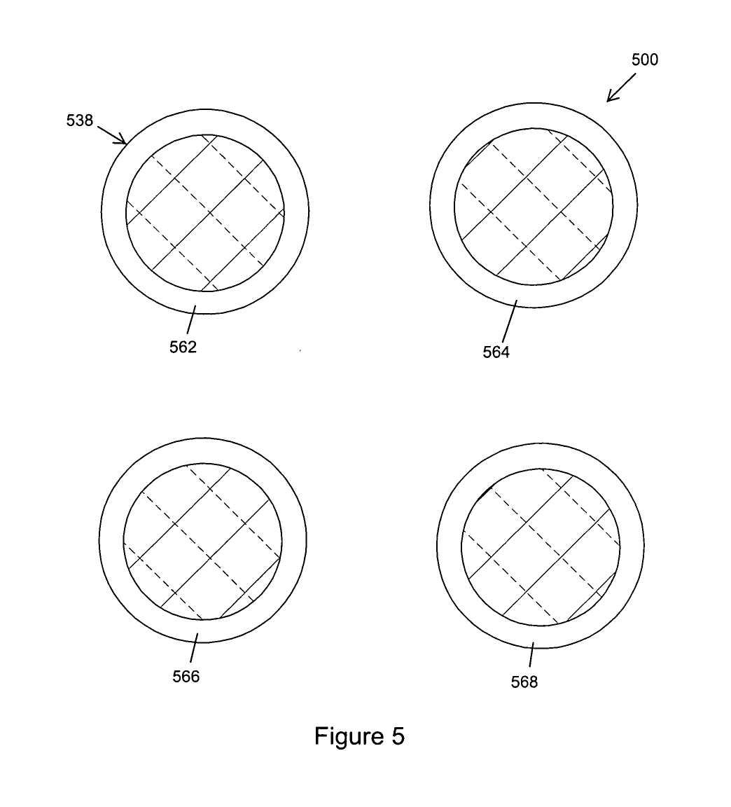

FIG. 5 is a simplified top view of a set 500 of four, alternative oxygenator filters 538. Alternatively, the set 500 can include more than four or fewer than four oxygenator filters 538. In this embodiment, the set 500 can include (i) a first oxygenator filter 562 having a first porosity; (ii) a second oxygenator filter 564 having a second porosity that is different from the first porosity; (iii) a third oxygenator filter 566 having a third porosity that is different from the first porosity and the second porosity; and (iv) a fourth oxygenator filter 568 having a fourth porosity that is different from the first porosity, the second porosity and the third porosity. With this design, the winemaker can selected the oxygenator filter 562-568 to use to achieve the desired flow rate and/or interchange the oxygenator filter 562-568 during the aging process as necessary or desired.

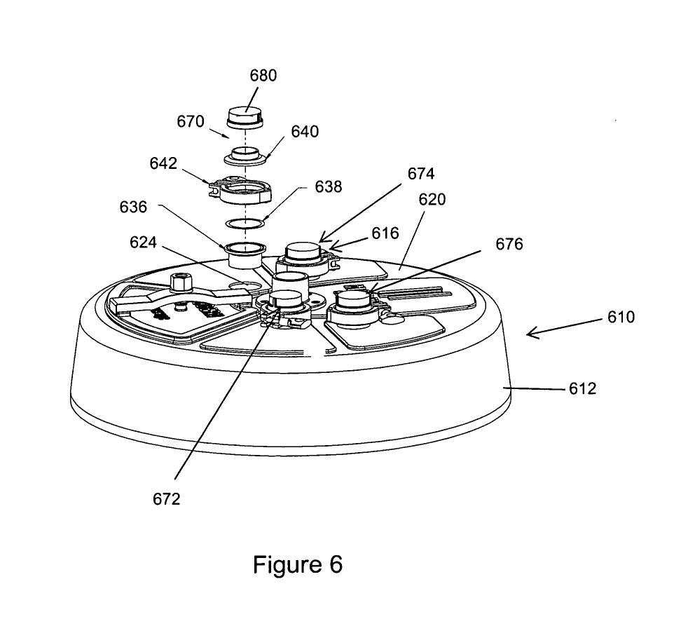

FIG. 6 is an exploded, perspective view of a portion of another embodiment of a container assembly 610. In this embodiment, only the upper portion of the container 612 is illustrated. Further, in the embodiment, the container assembly 610 includes four separate, spaced apart oxygenators 616 that are secured to the container top 620 of the container 612. In this embodiment, the oxygenators 616 can be labeled a first oxygenator 670, a second oxygenator 672, a third oxygenator 674, and a four oxygenator 676 that are similar to the oxygenator 16 described above and illustrated in FIGS. 1 and 2.

In this embodiment, the open oxygenators 616 cooperate to achieve the desired oxygen transfer rate. As alternative, non-exclusive examples, the combined open oxygenators 616 can cooperate to allow an oxygen transfer rate of approximately 0.5, 0.6, 0.7, 0.8, 0.9, 1, 1.1, 1.2, 1.3, 1.4, 1.5, or 2 milliliters of oxygen per liter of liquid, per month therethrough. Stated in another fashion, in alternative, non-exclusive examples, the combined open oxygenators 616 can be designed to allow an oxygen transfer rate of between approximately (i) 0.5 to 1.5 milliliters of oxygen per liter of liquid, per month therethrough; (ii) 0.6 to 1.4 milliliters of oxygen per liter of liquid, per month therethrough; (iii) 0.7 to 1.3 milliliters of oxygen per liter of liquid per month therethrough; (iv) 0.8 to 1.2 milliliters of oxygen per liter of liquid, per month therethrough; or (v) 0.9 to 1.1 milliliters of oxygen per liter of liquid, per month therethrough.

In yet another embodiment, as alternative, non-exclusive examples, the combined open oxygenators 616 can cooperate to allow an air transfer rate of approximately 0.5, 0.6, 0.7, 0.8, 0.9, 1, 1.1, 1.2, 1.3, 1.4, 1.5, or 2 milliliters of air per liter of liquid, per month therethrough. Stated in another fashion, in alternative, non-exclusive examples, the combined open oxygenators 616 can be designed to allow an air transfer rate of between approximately (i) 0.5 to 1.5 milliliters of air per liter of liquid, per month therethrough; (ii) 0.6 to 1.4 milliliters of air per liter of liquid, per month therethrough; (iii) 0.7 to 1.3 milliliters of air per liter of liquid per month therethrough; (iv) 0.8 to 1.2 milliliters of air per liter of liquid, per month therethrough; or (v) 0.9 to 1.1 milliliters of air per liter of liquid, per month therethrough.

In FIG. 6, the first oxygenator 670 is exploded and includes (i) an oxygenator base 636 that is fixedly attached to the container 612 (e.g. by welding) around the container aperture 624 and sealed to the container 612; (ii) an oxygenator filter 638; (iii) an oxygenator receiver flange 640; and (iv) an oxygenator clamp 642 that are similar to the corresponding components described above.

However, in FIG. 6, the oxygenator 670 includes a cap 680 that selectively seals the oxygenator receive flange 640 to function as an “on/off switch” allowing the invention to be used when needed and shut off when not needed. In this embodiment, cap 680 acts as a flow control device that controls the flow of the fluid through the breathable membrane 638. In this embodiment, the cap 680 snugly and selectively fits on the oxygenator receiver flange 640. The cap 680 can be of stainless steel or another non-porous material.

With this design, breathability characteristics are easily controlled and measurable by selectively removing or adding the cap 680 to one or more of the oxygenators 616. Thus, the invention is easily attachable and can be turned on and off when needed. When enough oxygen transfers into the liquid one or more of the oxygenators 616 can be closed off and the natural oxygen transfer will stop. If more oxygen is needed one or more of the oxygenators 616 can be opened up and additional oxygen transfer will take place. The number of oxygenators 616 in the open position or closed position also affects the amount of oxygen transfer.

In summary, the container assembly 610 will allow someone in the wine, beer, spirits or liquid aging industry the ability to control the exact amount of oxygen transfer into the container 612 holding the liquid. When more oxygen is needed one can simply open additional breathing devices 616 to increase the flow of oxygen transfer. When the desired result of oxygen transfer has taken place in the liquid the breathing device 616 can be simply closed. One or more breathing devices 616 of varying size or thickness can be mounted to the container 612 allowing for specific oxygen transfer depending on the intended use of the container 612. For example, one in the beer or spirits industry might want a different amount of oxygen transfer than someone in the wine industry. Thus, for the embodiment illustrated in FIG. 6, the user can open, zero, one, two, three and/or four of the breathing devices 616 to precisely adjust the oxygen flow into the otherwise sealed container 612.

It is also natural that the size of the container 612 would affect the amount of oxygen transfer required. Thus a larger container 612 would require larger membranes and possibly more of them located strategically around the container 612.

In this embodiment, the container 612 includes a container aperture 624 for each oxygenator 616.

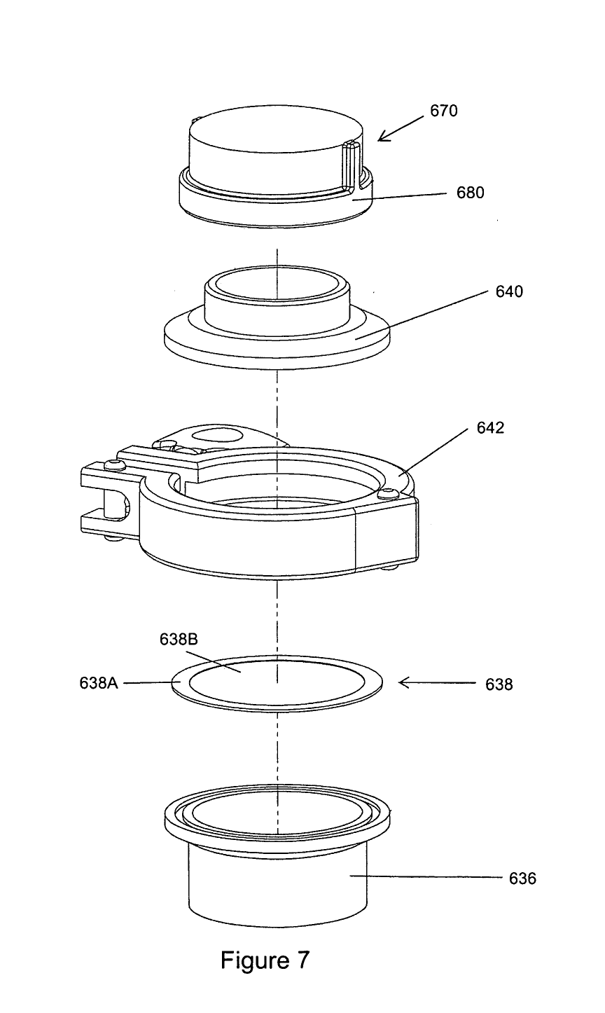

FIG. 7 is an exploded, perspective view illustrating the components of the first oxygenator 670 including (i) the oxygenator base 636; (ii) the oxygenator filter 638 including the support ring 638A and the membrane 638B; (iii) the oxygenator receiver flange 640; (iv) the oxygenator clamp 642; and (v) the cap 680.

While a number of exemplary aspects and embodiments of an oxygenator 16 have been discussed above, those skilled in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1-25. (canceled)

26. A container assembly for aging a liquid, the container assembly comprising:
a container that retains the liquid being aged, the container including a container top, a container bottom, a container side wall that extends between the container top and the container bottom, and a container aperture that extends through the container side wall; and
an oxygenator that is positioned adjacent to the container aperture, the oxygenator including (i) an oxygenator base that is fixedly attached to the container around the container aperture, and (ii) a first oxygenator filter that is attached to the oxygenator base, the first oxygenator filter including a support ring that contacts the oxygenator base, and a porous oxygenator membrane that is coupled to the support ring, the oxygenator membrane allowing oxygen to flow into the container through the oxygenator membrane and the container aperture, and the oxygenator membrane inhibiting the liquid being aged in the container from passing through the oxygenator membrane.

27. The container assembly of claim 26 wherein the liquid being aged in the container can be added into or removed from the container via the container aperture.

28. The container assembly of claim 26 wherein the container is made of a material that prevents the flow of oxygen through the container.

29. The container assembly of claim 26 wherein the oxygenator membrane has a porosity of approximately five percent.

30. The container assembly of claim 26 wherein the oxygenator membrane has a porosity that allows for the oxygen transfer of between 0.7 to 1.3 milliliters of oxygen per liter of liquid, per month through the oxygenator membrane.

31. The container assembly of claim 26 wherein the oxygenator further includes an oxygenator receiver flange that is positioned on top of the first oxygenator filter, and an oxygenator clamp that securely holds the oxygenator receiver flange on top of the oxygenator base with the support ring of the first oxygenator filter positioned therebetween.

32. The container assembly of claim 26 wherein the oxygenator includes a flow control device for controlling the flow of oxygen through the oxygenator membrane.

33. The container assembly of claim 32 wherein the flow control device includes a cap that covers the oxygenator membrane.

34. The container assembly of claim 26 wherein the container is positioned so that the oxygenator membrane remains dry during the aging process.

35. The container assembly of claim 26 further comprising a second oxygenator filter including a second support ring and a second oxygenator membrane, the first oxygenator filter having a first porosity and the second oxygenator filter having a second porosity that is different than the first porosity, and wherein the first oxygenator filter and the second oxygenator filter can be selectively interchanged during the aging process to adjust the air flow rate into the container.

36. The container assembly of claim 26 wherein the oxygenator is passive.

37. A method for aging a liquid, the method comprising:
retaining the liquid being aged within a container, including a container top, a container bottom, a container side wall that extends between the container top and the container bottom, and container aperture that extends through the container side wall; and
positioning an oxygenator adjacent to the container aperture, the oxygenator including (i) an oxygenator base that is fixedly attached to the container around the container aperture, and (ii) a first oxygenator filter that is attached to the oxygenator base, the first oxygenator filter including a support ring that contacts the oxygenator base, and a porous oxygenator membrane that is coupled to the support ring, the oxygenator membrane allowing oxygen to flow into the container through the oxygenator membrane and the container aperture, and the oxygenator membrane inhibiting the liquid being aged in the container from passing through the oxygenator membrane.

38. The method of claim 37 further comprising adding the liquid being aged into the container or removing the liquid being aged from the container via the container aperture.

39. The method of claim 37 wherein the container is made of a material that prevents the flow of oxygen through the container.

40. The method of claim 37 wherein the oxygenator membrane has a porosity of approximately five percent.

41. The method of claim 37 wherein the oxygenator membrane has a porosity that allows for the oxygen transfer of between 0.7 to 1.3 milliliters of oxygen per liter of liquid, per month through the oxygenator membrane.

42. The method of claim 37 wherein positioning includes the oxygenator further including an oxygenator receiver flange that is positioned on top of the first oxygenator filter, and an oxygenator clamp that securely holds the oxygenator receiver flange on top of the oxygenator base with the support ring of the first oxygenator filter positioned therebetween.

43. The method of claim 37 further comprising controlling the flow of oxygen through the oxygenator membrane with a flow control device.

44. The method of claim 37 further comprising positioning the container so that the oxygenator membrane remains dry during the aging process.

45. The method of claim 37 further comprising selectively interchanging the first oxygenator filter and a second oxygenator filter during the aging process to adjust the air flow rate into the container, the second oxygenator filter including a second support ring and a second oxygenator membrane, and the first oxygenator filter having a first porosity and the second oxygenator filter having a second porosity that is different than the first porosity.
